(19) United States
(12) Patent Application Publication
(10) Pub. No.: US 2009/0035204 A1
(43) Pub. Date: Feb. 5, 2009

(54) Methods for Synthesizing Lithium Iron Phosphate as a Material for the Cathode of Lithium Batteries

(75) Inventors: Zhongzhu Xu, Shenzhen (CN); Qiang Rong, Shenzhen (CN); Xiaobing Xi, Shenzhen (CN); Huadong Liao, Shenzhen (CN); Jianqun Wei, Shenzhen (CN)

Correspondence Address: Venture Pacific Law, PC, 5201 Great America Parkway, Suite 270, Santa Clara, CA, 95054, US

(73) Assignee: BYD Company Limited, Shenzhen (CN)

(21) Appl. No.: 12/135,128

(22) Filed: Jun. 6, 2008

(30) Foreign Application Priority Data
Jul. 31, 2007 (CN) 200710143408.4
Oct. 11, 2007 (CN) 200710152572.1

(51) Int. Cl. C01B 25/26

(52) U.S. Cl. 423/311

(57) ABSTRACT

A method for synthesizing lithium iron phosphate as a material for the cathode of lithium batteries is disclosed. This method comprises mixing and sintering the lithium source, iron source, phosphorous source, and carbon source, wherein said iron source is a mixture of FeC₂O₄ and FeCO₃, with a molar ratio of FeC₂O₄ to FeCO₃ of 1:0.5-4. The purity and specific capacity of lithium iron phosphate produced using are both relatively high, and the method of this invention is very safe in practice.

### CROSS REFERENCE

This application claims priority from a Chinese patent application entitled “A Type of Synthesis Method for the Lithium Battery Anode Material Lithium Iron Phosphate” filed on Jul. 31, 2007 and having a Chinese Application No. 200710143408.4, and a Chinese patent application entitled “A Method for Synthesizing the Rechargeable Lithium-ion Battery Anode Active Substance Lithium Iron Phosphate” filed on Oct. 11, 2007 and having a Chinese Application No. 200710152572.1. These applications are incorporated herein by reference.

### FIELD OF THE INVENTION

This invention relates to methods of synthesis for materials for the cathode of a lithium battery; more specifically, it relates to methods of synthesis of lithium iron phosphate as the material for the cathode of a lithium battery.

### BACKGROUND OF THE INVENTION

Olive-shaped LiFePO₄ has excellent electrochemical properties, and is well suited for use as an cathode material for lithium battery. LiFePO₄ has many advantages, such as excellent cycling properties and good high-temperature charge and discharge abilities; its base materials are widely available; it produces no environmental pollution; it has good thermal stability; and batteries manufactured using it are especially safe. All of these advantages mean that there is a massive future market for its use as a portable power source, especially in the field of batteries for electric cars.

At present, the most widely used synthesis method for lithium iron phosphate is high-temperature solid-state reaction. High-temperature solid-state reaction refers to the production method of directly baking an iron source compound, a lithium source compound, a phosphorous source compound, and a carbon source compound at a high temperature. This method has the advantages of requiring only simple facilities and being easily adapted for industrial production.

CN1948135A publicizes a solid-state reaction method for producing lithium iron phosphate. Said method includes mixing lithium hydroxide, ferrous oxalate, ammonium dihydrogen phosphate, and a polychlorinated alkene at normal temperature and pressure in an organic or water medium either by mechanical ball-milling or mechanical agitation. After drying, the mixture is placed in a temperature-controlled reaction furnace, and using a non-oxidized gas displacement reaction container, reacts in separate stages at controlled temperatures within the range 100-750° C. for 0.3-20 hours. After the reactant cools, it is mechanically ground and then sifted to obtain the black solid powder that is lithium iron phosphate cathode material. In said material, the mixing ratio of lithium hydroxide, ferrous oxalate, and ammonium dihydrogen phosphate depends on the lithium, iron, and phosphate radical contents; the molar ratio of lithium:iron:phosphate radical is 1:1:1, and the added amount of a polychlorinated alkene depends on the theoretical weight of material for synthesizing the lithium iron phosphate cathode material. This gives every 10 g of lithium iron phosphate cathode material synthesized a carbon content of 2-5%.

During the process of using the above-described solid-state reaction method to synthesize lithium iron phosphate, it is easy for Fe₂P impurities to form, resulting in low purity and relatively low specific capacity in the produced lithium iron phosphate. In addition, during the process of using the above-described solid-state reaction method to synthesize lithium iron phosphate, it is easy to generate H₂; when the density of H₂ reaches the explosive limit, H₂ can explode easily, making this method less safe to operate.

CN1785799A publicizes another solid-state method for synthesizing lithium iron phosphate. The iron source employed by this method is a ferrous salt, such as ferrous oxalate, ferrous acetate, ferrous chloride, etc.; the phosphorous source is ammonium phosphate, diammonium phosphate, monoammonium phosphate, etc. This method includes combining a lithium salt, the above described ferrous salt and phosphate salt, and a transition element compound all at once according to an atomic molar ratio of Li:Fe:P:TR=(1−x):1:1:x, then adding a grinding agent, ball-milling for 6-12 hours, and warm-drying at 40-70° C. The resulting dried powder is then heated to 400-550° C. in an environment of inert or reducing gas and maintained at this temperature for 5-10 hours for initial calcinations. The material is then ball-milled a second time for 6-12 hours and warm-dried at 40-70° C., then calcined again at 550-850° C. in an environment of inert gas or reducing gas to obtain the transition element powder compound lithium iron phosphate.

During the currently employed process of using divalent iron salt as a reactive material to synthesize lithium iron phosphate, inert gas must constantly be flowed in for protection and to prevent the oxidation of the divalent iron salt. Not only does this consume a great deal of inert gas, it also makes it easy for Fe₂P impurities to form in the produced lithium iron phosphate, thereby leading to rather high internal resistance and rather low specific capacity in batteries made from the produced lithium iron phosphate.

### SUMMARY OF THE INVENTION

One object of this invention is to provide synthesis methods for producing lithium iron phosphate with relatively high purity and specific capacity.

Another object of this invention is to provide synthesis methods producing lithium iron phosphate with a high level of operational safety.

Yet another object of this invention is to provide synthesis methods for producing lithium iron phosphate that when used in a battery it provides low internal resistance and high specific capacity.

Briefly, this invention provides one synthesis method for the lithium battery cathode material lithium iron phosphate; this method includes mixing and sintering the lithium source, iron source, phosphorous source, and carbon source, wherein said iron source is a mixture of FeC₂O₄ and FeCO₃, with a molar ratio of FeC₂O₄ to FeCO₃ being 1:0.5-4. Also, this invention provides synthesis methods for active substance lithium iron phosphate for the cathode of a rechargeable lithium-ion battery. This method includes sintering a mixture of a lithium compound, a divalent iron compound, a phosphorous compound, and a carbon source additive in an inert gas environment, then cooling the mixture to obtain a sintered product. Herein, during the sintering process, said inert gas environment is a static inert gas environment, and the pressure of said inert gas environment is normal atmospheric pressure.

An advantage of this invention is that it provides synthesis methods for producing lithium iron phosphate with relatively high purity and specific capacity.

Another advantage of this invention is that it provides synthesis methods producing lithium iron phosphate with a high level of operational safety.

Yet another advantage of this invention is that it provides synthesis methods for producing lithium iron phosphate that when used in a battery it provides low internal resistance and high specific capacity.

### DESCRIPTION OF THE DRAWINGS

FIG. 1 shows a XRD diffraction chart for lithium iron phosphate produced using one method of this invention.

FIG. 2 shows a XRD diffraction chart for lithium iron phosphate produced using a prior art method.

FIG. 3 shows a XRD diffraction chart for lithium iron phosphate produced using another method of this invention.

FIG. 4 shows a XRD diffraction chart for lithium iron phosphate produced using yet another method of this invention.

FIG. 5 shows a XRD diffraction chart for lithium iron phosphate produced using another prior art method.

FIG. 6 shows a XRD diffraction chart for lithium iron phosphate produced using yet another prior art method.

### DETAILED DESCRIPTION OF THE INVENTION

The inventor of this invention has discovered that the reason for which Fe₂P impurities and H₂ are easily produced during the process in the current high-temperature solid-state reaction method for production of lithium iron phosphate is that under high temperatures (e.g. 100-750° C.), FeC₂O₄.2H₂O breaks down and yields large amounts of CO and H₂O. Although CO can prevent the oxidation of Fe²⁺ into Fe³⁺, because the amount of CO produced is very large, some CO reduces Fe²⁺ and PO₄³⁻, separately, into elemental Fe and elemental P. At 600-720° C. temperatures, elemental Fe and elemental P react to form Fe₂P; H₂O and elemental Fe react to form H₂, and H₂ can also reduce Fe²⁺ and PO₄³⁻ into elemental Fe and elemental P, thereby producing Fe₂P.

This invention provides one synthesis method for the lithium battery cathode material lithium iron phosphate; this method includes mixing and sintering the lithium source, iron source, phosphorous source, and carbon source, wherein said iron source is a mixture of FeC₂O₄ and FeCO₃, with a molar ratio of FeC₂O₄ to FeCO₃ being 1:0.5-4.

Compared to the prior art methods of using ferrous oxalate as the only iron source, the synthesis methods for lithium iron phosphate provided by this invention uses a mixture of FeC₂O₄ and FeCO₃ with a molar ration of 1:0.5-4 as the iron source, resulting in relatively little CO formed during the process of sintering the lithium source, iron source, and phosphorous source. The CO formed only serves to prevent the oxidation of Fe²⁺ into Fe³⁺, and will not reduce Fe²⁺ into elemental Fe or reduce PO₄³⁻ into elemental P, thereby preventing the generation of Fe₂P. This process results in a relatively high-purity lithium iron phosphate, and raises the lithium iron phosphate's specific capacity. At the same time, because of the lack of H₂O or elemental Fe formed, H₂ is not generated, thereby increases the operational safety.

The inventor of this invention has also discovered that during the entire process of using one or more ferrous salts, such as ferrous oxalate, ferrous acetate, and ferrous chloride, one or more phosphorous salts, such as ammonium phosphate, diammonium phosphate, and momoammonium phosphate, and a lithium salt as reactive materials to create lithium iron phosphate, inert gas must be constantly flowed in to prevent the oxidation of the divalent iron, and in addition Fe₂P impurities are easily formed during the reaction process. This process results in rather high internal resistance and rather low specific capacity in batteries made from this lithium iron phosphate.

This invention provides another synthesis method for active substance lithium iron phosphate for the cathode of a rechargeable lithium-ion battery. This method includes sintering a mixture of a lithium compound, a divalent iron compound, a phosphorous compound, and a carbon source additive in an inert gas environment, then cooling the mixture to obtain a sintered product. Herein, during the sintering process, said inert gas environment is a static inert gas environment, and the pressure of said inert gas environment is normal atmospheric pressure.

In the synthesis process for lithium iron phosphate described above, the described inert gas environment during the sintering process is a static environment, and the pressure of the described inert gas environment is normal atmospheric pressure. This means that, during the baking process, no inert gas is flowed in; only the inert gas added before baking and the non-oxidized gases produced by the decomposition of reactant materials during the baking process are relied upon as protective gases to prevent the oxidation of Fe²⁺ into Fe³⁺. The lithium iron phosphate produced using the method of this invention contains no Fe₂P impurities, and batteries built with this lithium iron phosphate have high capacity, low internal resistance, and excellent cycling properties. The initial specific discharge capacity of a battery built with the lithium iron phosphate produced by the method described in Embodiment 11 of this invention is 150 mAh/g, and said battery's internal resistance is low, at only 25-30 mΩ. In comparison, the initial specific discharge capacity of a battery constructed using the lithium iron phosphate produced by the method described in Comparison Embodiment 3 of this invention is only 112 mAh/g, and said battery's internal resistance is 200-300 mΩ.

One method provided by this invention includes mixing and sintering a lithium source, iron source, phosphorous source, and carbon source, wherein said iron source is a mixture of FeC₂O₄ and FeCO₃ with a molar ratio of 1:0.5-4.

The described FeC₂O₄ and FeCO₃ should preferably have a molar ratio of 1:1.5-4. The FeC₂O₄ and FeCO₃ mixture can be obtained by mixing anhydrous ferrous oxalate and anhydrous ferrous carbonate with a molar ratio of 1:0.5-4. It can also be the product of heating ferrous oxalate; said heating can be conducted at temperatures of 100-350° C., preferably at 120-300° C., and can last 0.2-6 hours, preferably 0.5-5 hours.

The method described below can be used to calculate the molar ratio of FeC₂O₄ and FeCO₃ in the product obtained through heating ferrous oxalate in order to determine the degree of reactivity of a ferrous oxalate decomposition reaction.

Suppose the mass of FeC₂O₄.2H₂O added is Xg, and the mass of the FeC₂O₄ and FeCO₃ mixture obtained after heating the FeC₂O₄.2H₂O is Yg. Then the molar ratio of FeC₂O₄ and FeCO₃ will be (179.902Y−115.86X):(143.87X−179.902Y, wherein 179.902 is the molecular weight of FeC₂O₄.2H₂O, 115.86 is the molecular weight of FeCO₃, and 143.87 is the molecular weight of FeC₂O₄.

The described heating of ferrous oxalate should preferably be conducted in vacuum, which allows for the speedy removal of any CO formed through decomposition and prevents CO from reducing Fe²⁺ into Fe. The pressure in the vacuum can be 100-1000 Pa, but preferably is 200-700 Pa. Here, pressure refers to absolute pressure. A standard vacuum apparatus can be used, such as a vacuum pump or vacuum oven to create the above-described vacuum.

After heating ferrous oxalate under the above-described conditions, the resulting product can either be directly mixed with the lithium source, phosphorous source, and carbon source, or cooled to room temperature and then mixed with the lithium source, phosphorous source, and carbon source. The speed of cooling can be 1-10° C./min.

Standard methods can be used for mixing the lithium source, iron source, phosphorous source, and carbon source. Preferably, in order to mix more evenly, the lithium source, iron source, phosphorous source, and carbon source can be ball-milled with a dispersing agent. Said ball-milling method includes feeding the lithium source, iron source, phosphorous source, and carbon source, along with the dispersing agent into a ball-milling machine to conduct ball-milling, and then warm-drying. Said dispersing agent can be one or more standard organic solvent(s), such as methyl alcohol, ethanol, or acetone. The amount of the dispersing agent should be 70-120% in weight of the total amount of iron source, lithium source, phosphorous source, and carbon source. The condition required for ball-milling is that the above-described substances be mixed evenly; for example, ball-milling time can be 3-12 hours. The only condition for warm drying is that the above-described dispersing agent be completely evaporated; for example, warm-drying temperature can be 30-80° C., and warm-drying time can be 2-10 hours.

The mixing ratio of the described lithium source, iron source, and phosphorous source can be the standard mixing ratio; for example, the molar ratio of the iron source, lithium source, and phosphorous source can be Fe:Li:P=1:0.95-1.1:0.95-1.1. The amount of carbon source used is 0.5-10% in weight of the total amount of iron source, lithium source, and phosphorous source.

The described lithium source can be one or more of the many standard lithium compounds used for synthesizing lithium iron phosphate, such as lithium hydroxide, lithium carbonate, lithium acetate, lithium nitrate, lithium phosphate, lithium hydrogen phosphate, and lithium dihydrogen phosphate.

The described phosphorous source can be one or more of the many standard phosphorous compounds used for synthesizing lithium iron phosphate, such as ammonium phosphate, ammonium hydrogen phosphate, ammonium dihydrogen phosphate, lithium phosphate, lithium hydrogen phosphate, and lithium dihydrogen phosphate.

The described carbon source can be one or more of the many standard carbon compounds used for synthesizing lithium iron phosphate, such as dextrose, sucrose, starch, and carbon black.

The described sintering method can be a standard sintering method used for synthesizing lithium iron phosphate; for example, the sintering method can include conducting the initial sintering of the lithium source, iron source, phosphorous source, and carbon source at the initial sintering temperature in a protective environment of inert gas, then conducting the second sintering at the second sintering temperature.

The described initial sintering temperature can be 300-450° C., and the initial sintering duration can be 4-15 hours. Before the initial sintering, the lithium source, iron source, phosphorous source, and carbon source can be heated from room temperature to the initial sintering temperature at a rate of 2-20° C./min; after the initial sintering, the sintering product can be cooled from the initial sintering temperature to room temperature at a rate of 5-15° C./min.

The described second sintering temperature can be 600-800° C., and the second sintering duration can be 10-25 hours. Before the second sintering, the sources can be heated from room temperature to the second sintering temperature at a rate of 10-30° C./min; after the second sintering, the sintering product can be cooled from the second sintering temperature to room temperature at a rate of 2-12° C./min.

The described protective inert gas can be N₂ or Ar.

Below, some embodiments are given for further clarification.

### EMBODIMENT 1

Heat 3047 g of FeC₂O₄.2H₂O in a 280° C. vacuum-heating chamber (with a pressure of 500 Pa) for 3 hours to obtain a mixture of FeC₂O₄ and FeCO₃, then cool to room temperature at a rate of 5° C./min. The molar ratio of FeC₂O₄ and FeCO₃ in said mixture can be calculated as 1:3; mix said mixture with 626 g of LiCO₃, 1948 g of NH₄PO₄, 337.6 g of dextrose, and 4500 g of industrial alcohol, then place the resulting slurry into a ball-rolling container, with a ball-to-material mass ratio of 2:1; seal the container and ball-mill for 6 hours; and place the ball-milled slurry in a 50° C. heating chamber, and warm-dry for 8 hours to dry out the alcohol. Afterwards, heat the resulting dried mixture to 380° C. in a protective environment of nitrogen gas at a rate of 3° C./min. Sinter for 10 hours at 380° C., then cool to room temperature at a rate of 10° C./min. Afterwards, heat to 750° C. at a rate of 10° C./min, then sinter at 750° C. for 18 hours, and finally cool to room temperature at a rate of 1° C./min to obtain the cathode material LiFePO₄/C.

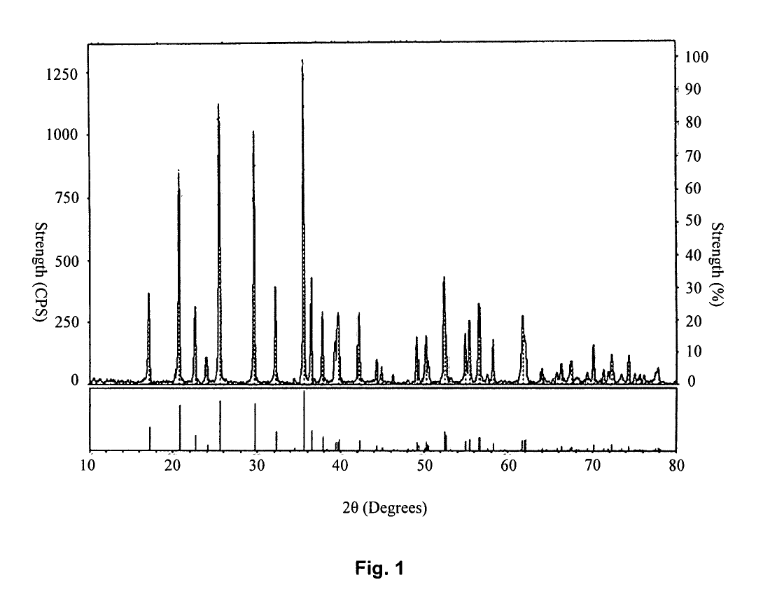

The XRD diffraction pattern produced by testing this lithium iron phosphate material with X-ray powder diffractometer, D/MAX2200PC model from Japanese Rigaku company, is shown in FIG. 1.

### COMPARISON EMBODIMENT 1

Use the same method described in Embodiment 1 to obtain the cathode material LiFePO₄/C, with the difference being that the FeC₂O₄.2H₂O is not heated to 280° C., but rather directly mixed FeC₂O₄.2H₂O with the other materials.

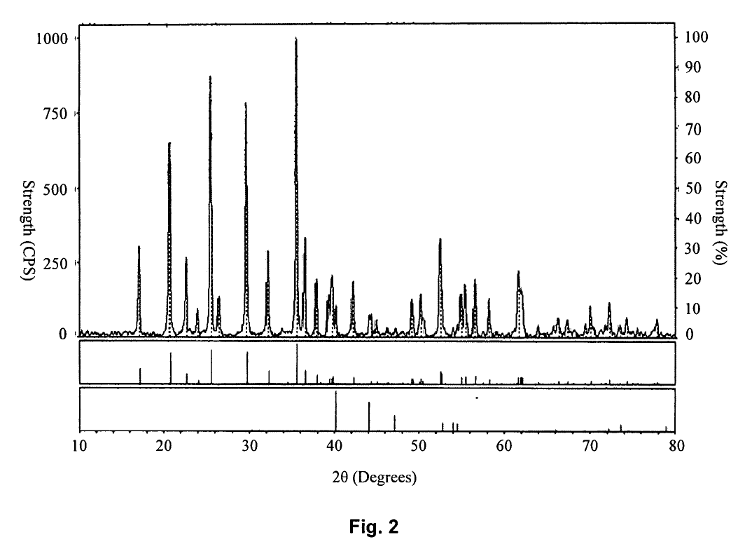

The XRD diffraction pattern produced by testing this lithium iron phosphate material with X-ray powder diffractometer, D/MAX2200PC model from Japanese Rigaku company, is shown in FIG. 2.

### EMBODIMENT 2

Use the same method described in Embodiment 1 to obtain the cathode material LiFePO₄/C, with the difference being that the FeC₂O₄.2H₂O is placed in a 120° C. vacuum-heating chamber (with a pressure of 300 Pa) and heated for 0.5 hours to obtain a mixture of FeC₂O₄ and FeCO₃ with a molar ratio of 1:1.5.

### EMBODIMENT 3

Use the same method described in Embodiment 1 to obtain the cathode material LiFePO₄/C, with the difference being that the FeC₂O₄.2H₂O is placed in a 300° C. vacuum-heating chamber (with a pressure of 700 Pa) and heated for 5 hours to obtain a mixture of FeC₂O₄ and FeCO₃ with a molar ratio of 1:4.

### EMBODIMENT 4

Use the same method described in Embodiment 1 to obtain the cathode material LiFePO₄/C, with the difference being that the FeC₂O₄.2H₂O is placed in a 200° C. vacuum-heating chamber (with a pressure of 200 Pa) and heated for 2 hours to obtain a mixture of FeC₂O₄ and FeCO₃ with a molar ratio of 1:2.

### EMBODIMENT 5

Use the same method described in Embodiment 1 to obtain the cathode material LiFePO₄/C, with the difference being that the product resulting from heating FeC₂O₄.2H₂O is not used as an iron source, but rather a mixture of FeC₂O₄ and FeCO₃ with a molar ratio of 1:3 is mixed with the other materials.

### EMBODIMENTS 6-10

Embodiments 6-10 are used to determine the properties of the cathode materials obtained through embodiments 1-5.

Follow the steps below to determine the specific capacity of the lithium iron phosphate.

Separately add 100 g of the cathode material LiFePO₄/C obtained through embodiments 1-5, 3 g of the bonding agent polyvinylidene fluoride (PVDF) and 2 g of the conductive agent acetylene black to 50 g of N-Methyl pyrrolidone, then stir evenly to obtain an cathode slurry. Spread the obtained cathode slurry evenly over both sides of a 20 micrometer thick sheet of aluminum foil, then warm dry at 150° C., compress using a roller, and cut into cathodes measuring 540×43.5 mm, each containing 2.8 g of the active ingredient LiFePO₄/C.

Add 100 g of the anode active ingredient natural graphite, 3 g of the bonding agent polyvinylidene fluoride (PVDF), and 3 g of the conductive agent carbon black to 100 g of N-Methyl pyrrolidone, then stir evenly to obtain a anode slurry. Spread the obtained anode slurry evenly over both sides of a 12 micrometer thick sheet of copper foil, then warm dry at 90° C., compress using a roller, and cut into 500×44 mm anodes, each containing 2.6 g of the active ingredient natural graphite.

Separately roll the obtained cathodes and anodes with a polypropylene membrane into a rectangular lithium-ion battery core, then dissolve LiFP₆ with a density of 1 mol/L in an EC/EMC/DEC=1:1:1 solvent mixture to produce a non-aqueous electrolyte solution; feed said electrolyte solution in an amount of 3.8 g/Ah into the aluminum battery shell and seal to produce rechargeable lithium ion batteries A1-A5.

Separately place the A1-A5 lithium-ion batteries as created above in a testing cabinet; first charge at a constant flow of 0.2 C with a maximum voltage of 3.8V, then charge at a constant voltage for 2.5 hours. Set the battery aside for 20 minutes, then discharge the battery with a current of 0.2 C from 3.8V down to 3.0V; record the battery's initial discharge capacity, and use the formula below to calculate the specific capacity of the active cathode material (i.e. the lithium iron phosphate).

Specific capacity=battery's initial discharge capacity (mAh)/weight of cathode active material (g)

Test results are shown in Chart 1 below.

### COMPARISON EMBODIMENT 2

This comparison embodiment is used to determine the properties of the cathode material obtained through comparison embodiment 1.

The results of using the same method as in embodiments 6-10 to determine the properties of the cathode active material obtained through comparison embodiment 1 are shown in Chart 1.

CHART 1

| | | | | | | Comp. |
|---|---|---|---|---|---|---|
| Embodiment | Embod. | Embod. | Embod. | Embod. | Embod. | Embod. |
| # | 6 | 7 | 8 | 9 | 10 | 2 |
| Specific | 125 | 117 | 115 | 118 | 123 | 106 |
| Capacity | | | | | | |
| (mAh/g) | | | | | | |

FIG. 1 is a XRD diffraction pattern produced by the lithium iron phosphate synthesized using a method of this invention. The top section shows the pattern produced by the lithium iron phosphate, while the bottom section shows the pattern produced by standard lithium iron phosphate. FIG. 2 is a XRD diffraction pattern produced by lithium iron phosphate synthesized using prior art methods. The top section shows the pattern produced by the lithium iron phosphate; the middle section shows the pattern produced by standard lithium iron phosphate; the bottom section shows the pattern produced by standard Fe₂P.

From FIG. 1, it can be seen that the XRD diffraction pattern produced by the lithium iron phosphate synthesized using a method of this invention is the same as the JADE pattern produced by standard lithium iron phosphate. This shows that the substance tested in FIG. 1 is pure lithium iron phosphate. From FIG. 2, it can be seen that the XRD diffraction pattern produced by lithium iron phosphate synthesized using the comparison method (comparison embodiment 1) contains more erratic peaks than the JADE pattern produced by standard lithium iron phosphate, and that these erratic peaks match up exactly with the pattern produced by standard Fe₂P. Thus it can be determined that the substance tested in FIG. 2 contains Fe₂P impurities. Therefore it can be said that the lithium iron phosphate cathode active material of this invention has higher purity.

From the data in Chart 1 it can be seen that the specific capacities of the lithium iron phosphate active cathode materials tested in embodiments 6-10 are clearly higher than the specific capacity of the lithium iron phosphate active cathode material tested in comparison embodiment 2. This shows that using the method of this invention can noticeably increase the specific capacity of the lithium iron phosphate cathode active material created.

Another method provided by this invention includes sintering a mixture containing a lithium compound, a divalent iron compound, a phosphorous compound, and a carbon source additive in an inert gas environment, then cooling to obtain a sintered product; wherein, during the sintering process, said inert gas environment is a static inert gas environment, and the pressure of said inert gas environment is normal atmospheric pressure.

The sintering process described in the paragraph above can be conducted in different reaction apparatuses; all that is necessary is to ensure that during the sintering process, said inert gas environment is a static inert gas environment, and that the pressure of said inert gas environment is normal atmospheric pressure. For example, said sintering is conducted in a reaction container equipped with a gas inlet and a gas outlet. Before sintering, inert gas is flowed into the reaction container to replace the air in said reaction container. During the sintering process, the gas inlet is kept closed, and the gas outlet is connected pressure-tight to one end of a tube, the other end of the tube is placed in a hydraulic fluid. During the sintering process described in this invention, inert gas no longer flows into the reaction container. The fact that the pressure-tight connection between the gas outlet of said reaction container and one end of a tube and the other end of the tube is placed in hydraulic fluid is sufficient to ensure that the gas produced during the sintering reaction is discharged after passing through the hydraulic fluid. This satisfies the requirement that during the sintering process, the described inert gas environment be a static inert gas environment, and is also sufficient to ensure that the pressure of said inert gas environment is normal atmospheric pressure.

“Normal atmospheric pressure” as described in this invention refers to a standard atmospheric pressure, which is 1.01×10⁵ Pa. Due to geographical location, altitude, and temperature differences, every location's actual atmospheric pressure differs from standard atmospheric pressure; for simplification, “normal atmospheric pressure” as described in this invention refers to a standard atmospheric pressure.

“Static inert gas environment” as described in this invention refers to an environment without circulation or flow; that is to say, during the sintering process, all inflow of inert gas is ceased.

The reason for connecting the gas outlet to a hydraulic fluid by a tube during the sintering process is to prevent the entry of air into the reaction container—which would result in the oxidation of the lithium iron phosphate—as well as to maintain the normal atmospheric pressure inside the reaction container. Therefore, under ideal conditions, the method of connecting the described gas outlet with a hydraulic fluid is best carried out by placing the tube at a depth of 5-8 cm below the surface of the hydraulic fluid.

There are no specific limitation on the number of the described gas inlet and outlet equipped on the reaction container nor their location; as long as they ensure that the described inert gas can be flowed into the reaction container to replace the air inside the reaction container, the gas produced during the reaction can be discharged through the gas outlet, and the pressure inside the described inert gas environment is maintained at normal atmospheric pressure. Preferably, in order to facilitate air replacement and the discharge of gases produced during the sintering process, said gas inlet and outlet should be located on one single side of the reaction container, even more preferably on one single vertical plan, with the gas inlet located below the gas outlet. When the inert gas is flowing into the reaction container, there is no specific restriction on the flow speed of said inert gas; the flow speed is normally 5-20L/min.

There are also no specific restrictions on the size or material of said reaction container; people of ordinary skill in the art can select an appropriate size and material for the reaction container based on production needs.

Because hydrogen gas, ammonia gas, carbon monoxide gas, and carbon dioxide gas can be produced during the process of sintering a mixture containing a lithium compound, a divalent iron compound, a phosphorous compound, and a carbon source additive at constant temperature in an inert gas environment, and because the sintering temperature is relatively high, under the preferred conditions, in order to prevent reverse-siphoning of the hydraulic fluid, the hydraulic fluid should be a fluid that is not reactive with the gas produced during the sintering process and has a boiling point no lower than 140° C., such as one of the following fluids: hydraulic oil, quenching oil, or high-temperature resistant lubricating oil.

The described inert gas environment refers to any gas or gas mixture that does not chemically react with the reactants or products of the reaction, such as one or more of the following inert gases: nitrogen gas, carbon dioxide, ammonia gas, or gases from group 0 of the periodic table of elements. The molar ratio of the described lithium compound, divalent iron compound, iron phosphate, and phosphorous compound is Li:Fe:P=(0.9-1.2):1:1.

The described divalent iron compound can be chosen from one or more of the many divalent iron compounds used in the synthesis of lithium iron phosphate that are commonly known in this field, such as: FeC₂O₄, Fe(CH₃COO)₂, and FeCO₃.

The described lithium compound can be chosen from one or more of the many lithium compounds used in the synthesis of lithium iron phosphate that are commonly known in this field, such as: Li₂CO₃, LiOH, Li₂C₂O₄, and CH₃COOLi.

The described phosphorous compound can be chosen from one or more of the phosphorous compounds used in the synthesis of lithium iron phosphate that are commonly known in this field, such as: NH₄H₂PO₄, (NH₄)₂HPO₄, LiH₂PO₄, (NH₄)₃PO₄.

The described carbon source additive can be one or more of the additives well known in this field that have an electrical conductive property, such as: copoly (benzene/naphthalene/phenanthrene), copoly(benzene/phenanthrene), copoly (benzene/anthracene), polyphenyl, soluble starch, polyvinyl alcohol, sucrose, dextrose, citric acid, starch, dextrin, phenolic aldehyde resin, furfural resin, artificial graphite, natural graphite, super-conductive acetylene black, acetylene black, carbon black, and intermediate-phase carbon microspheres (or molecular and cellular medicine ball/board). During the sintering process, a part of said carbon source additive dissolves under high temperatures into carbon monoxide and carbon dioxide and is released; the other part of the carbon source additive mixes in with the produced lithium iron phosphate to improve the conductive properties of the lithium iron oxide. The amount of said carbon source additive causes the produced lithium iron phosphate to have a carbon content of 1-10% in weight, ideally 3-5% in weight.

The described mixture containing a lithium compound, a divalent iron compound, a phosphorous compound, and a carbon source additive can be mechanically mixed, and is preferably obtained through ball-milling. Said ball-milling method includes first mixing the lithium compound, divalent iron compound, phosphorous compound, and carbon source additive, along with an organic solvent, then ball milling; the type and amount of said organic solvent are well known to those ordinary skill in the art, such as ethanol and/or propyl alcohol; the ratio of the amount organic solvent used to the amount of the described mixture can be 1.5:1. There are no specific restrictions on ball-milling speed and time; these can be decided according to grain size requirements. Preferably, the method should include a drying step for said mixture after ball-milling is completed; the method and conditions of drying are well known to those ordinary skills in the art.

The sintering method can be one of many methods known by ordinary skill in the art, such as one-stage sintering or two-stage sintering. Preferably, in order to reduce the number of required steps and to increase production efficiency, this invention uses a method of constant temperature one-stage sintering. The temperature of said constant temperature one-stage sintering is 500-750° C., preferably 700-750° C., and the constant temperature sintering time is 2-20 hours, preferably 10-20 hours. In order to further control the shape of the lithium iron phosphate granules and allow the lithium iron phosphate to develop a more complete crystalline structure, preferably, the constant temperature one-stage sintering process described in this invention uses a speed of 5-20° C./min, preferably 10-15° C./min, to increase temperature to the constant temperature sintering temperature, then conducting sintering at that constant temperature.

The cooling method can be one of many methods commonly known to those ordinary skilled in the art, such as natural cooling. In order to prevent the oxidation of the produced lithium iron phosphate, the sintering product will preferably be cooled to room temperature in an inert gas environment. The inert gas atmosphere can be static atmosphere and the preferred flow speed is 2-20 L/min flowing atmosphere.

Below, some examples are given for further clarification.

### EMBODIMENT 11

This embodiment describes the synthesis of the cathode active substance lithium iron phosphate provided by this invention.

(1) Mix 369 g of Li₂CO₃, 1799 g of FeC₂O₄.2H₂O, 1150 g of NH₄H₂PO₄, and 300 g of dextrose, along with 3000 g of ethyl alcohol (with a molar ratio of Li:Fe:P=1:1:1), and ball-mill for 10 hours at a rate of 300 rpm; remove, and warm dry at 80° C.

(2) Place the mixture from step (1) in a reaction container equipped with a gas inlet and gas outlet (with the gas inlet and gas outlet located on the same vertical plan of the container, the gas inlet being below the gas outlet). Open the gas inlet and gas outlet, and pump in argon gas at a rate of 5 L/min to replace the air inside the reaction container, then close the gas inlet, connect the gas outlet to a tube, and place the tube into 25° C. hydraulic oil (Caltex, top-grade hydraulic oil 46#) (with the mouth of the tube 5 cm below the surface of the hydraulic oil). Raise the temperature at a rate of 10° C./min to 750° C. and sinter at that constant temperature for 20 hours. Open the gas inlet, and pump in argon gas at a rate of 5 L/min to cool the resulting product down to room temperature to obtain the rechargeable lithium-ion battery cathode active material lithium iron phosphate. The resulting lithium iron phosphate has a carbon content of 3.52%, as gauged using an IR Carbon-Sulfur Analyzer. The gauging method is as follows: measure out a 0.03-0.5 g sample, and place it into the specialized crucible, then add 0.6-0.7 g of pure iron co-solvent, 1.8-1.9 g of tungsten granules as a combustion promoter, place in at high frequency/high temperature, using oxygen to serve as a combustion promoter and carrier gas. Take the CO₂ produced after burning to the carbon analysis pool, then use the analyzer to gauge the carbon content of the lithium iron phosphate.

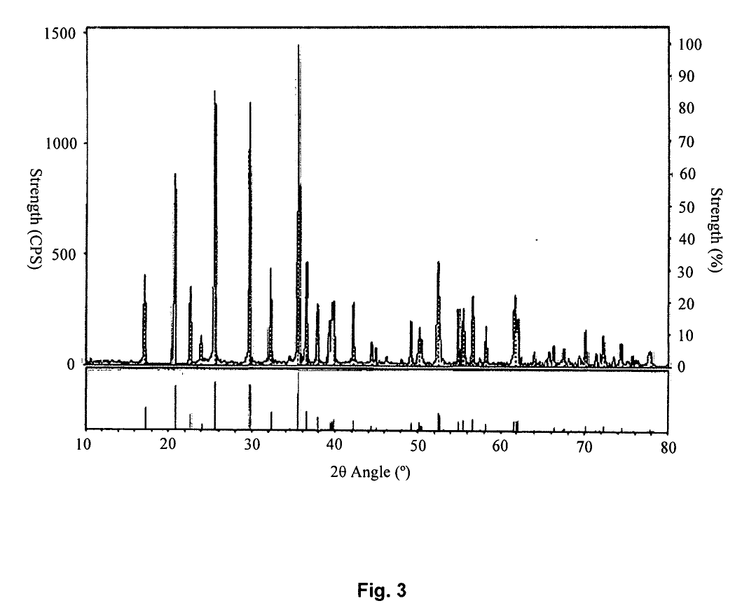

The XRD diffraction pattern produced by testing this lithium iron phosphate material with Rigaku's D/MAX2200PC model powder X-ray diffractometer is shown in FIG. 3.

### EMBODIMENT 12

This embodiment describes the synthesis of the cathode active substance lithium iron phosphate according to this invention.

(1) Mix 239.5 g of LiOH, 1158.6 g of FeCO₃, 1319.7 g of (NH₄)₂HPO₄, and 320 g of dextrose, along with 2700 g of ethyl alcohol (with a molar ratio of Li:Fe:P=1:1:1), and ball-mill for 10 hours at a rate of 300 rpm; extract, and warm dry at 80° C.

(2) Place the mixture from step (1) in a reaction container equipped with a gas inlet and gas outlet (with the gas inlet and gas outlet located on the same vertical side of the container, the gas inlet below the gas outlet). Open the gas inlet and gas outlet, and pump in argon gas at a rate of 5 L/min to replace the air in the reaction container, then close the gas inlet, connect the gas outlet to a tube, and place the tube into 25° C. hydraulic oil (with the mouth of the tube 5 cm below the surface of the hydraulic oil). Raise the temperature at a rate of 5° C./min to 700° C. and sinter at that constant temperature for 20 hours. Open the gas inlet, and pump in argon gas at a rate of 5 L/min to cool the resulting product down to room temperature to obtain the rechargeable lithium-ion battery cathode active material lithium iron phosphate. The produced lithium iron phosphate has a carbon content at 3.47% in weight.

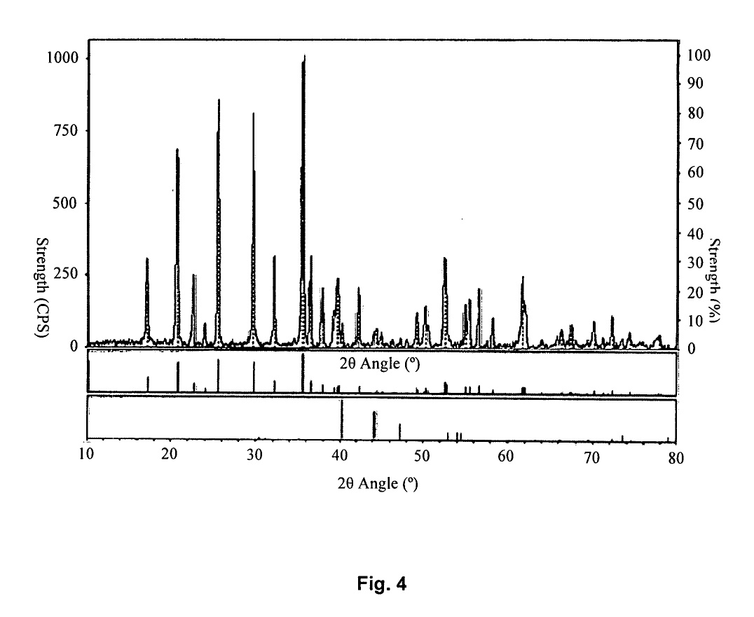

The XRD diffraction pattern produced by testing this lithium iron phosphate material with Rigaku's D/MAX2200PC model powder X-ray diffractometer is shown in FIG. 4.

### EMBODIMENT 13

This embodiment describes the synthesis of the cathode active substance lithium iron phosphate provided by this invention.

(1) Mix 369 g of Li₂CO₃, 1799 g of FeC₂O₄.2H₂O, 1150 g of NH₄H₂PO₄, and 310 g of sucrose, along with 3000 g of ethyl alcohol (with a molar ratio of Li:Fe:P=1:1:1), and ball-mill for 10 hours at a rate of 300 rpm; remove, and warm dry at 80° C.

(2) Place the mixture from step (1) in a reaction container equipped with a gas inlet and gas outlet (with the gas inlet and gas outlet located on the same vertical plan of the container, the gas inlet being below the gas outlet). Open the gas inlet and gas outlet, and pump in argon gas at a rate of 5 L/min to replace the air in the reaction container, then close the gas inlet, connect the gas outlet to a tube, and place the tube into 25° C. hydraulic oil (with the mouth of the tube placed 5 cm below the surface of the hydraulic oil). Raise the temperature at a rate of 15° C./min to 750° C. and sinter at that constant temperature for 20 hours. Open the gas inlet, and pump in argon gas at a rate of 5 L/min to cool the resulting product down to room temperature to obtain the rechargeable lithium-ion battery cathode active material lithium iron phosphate. The produced lithium iron phosphate has a carbon content at 3.8% in weight.

### EMBODIMENT 14

This embodiment describes the synthesis of the cathode active substance lithium iron phosphate provided by this invention.

(1) Mix 369 g of Li₂CO₃, 1799 g of FeC₂O₄.2H₂O, 1319.7 g of (NH₄)₂HPO₄, and 310 g of sucrose, along with 3000 g of ethyl alcohol (with a molar ratio of Li:Fe:P=1:1:1), and ball-mill for 10 hours at a rate of 300 rpm; remove, and warm dry at 80° C.

(2) Place the mixture from step (1) in a reaction container equipped with a gas inlet and gas outlet (with the gas inlet and gas outlet located on the same vertical plan of the container, the gas inlet being below the gas outlet). Open the gas inlet and gas outlet, and pump in argon gas at a rate of 5 L/min to replace the air in the reaction container, then close the gas inlet, connect the gas outlet to a tube, and place the tube into 25° C. hydraulic oil (with the mouth of the tube 5 cm below the surface of the hydraulic oil). Raise the temperature at a rate of 10° C./min to 700° C. and sinter at that constant temperature for 20 hours. Open the gas inlet, and pump in argon gas at a rate of 5 L/min to cool the resulting product down to room temperature to obtain the rechargeable lithium-ion battery cathode active material lithium iron phosphate. The produced lithium iron phosphate has a carbon content at 3.56% in weight.

### COMPARISON EMBODIMENT 3

This comparison embodiment describes the currently used method of synthesis for the cathode active material lithium iron phosphate.

Use the method described in Embodiment 11 to synthesize lithium iron phosphate, with the only difference being that in step (2), the mixture from step (1) is placed into a reaction container equipped with a gas inlet and gas outlet (with the gas inlet and gas outlet located on the same vertical plan of the container, the gas inlet being below the gas outlet); the gas inlet and gas outlet are opened, and argon gas is pumped in at a rate of 5 L/min to replace the air in the reaction container, then argon gas continues to be pumped in at an adjusted flow rate of 2 L/min; the temperature is raised at a rate of 10° C./min to 750° C. and sintering is conducted at that constant temperature for 20 hours. Afterwards, argon gas continues to be pumped in to cool the resulting product down to room temperature to obtain the rechargeable lithium-ion battery cathode active material lithium iron phosphate. The produced lithium iron phosphate has a carbon content at 3.57% in weight.

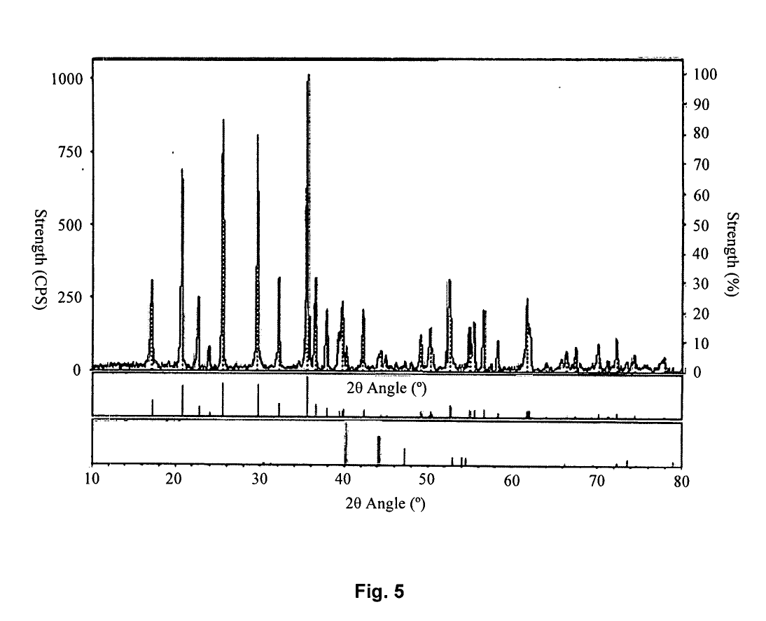

The XRD diffraction pattern produced by testing this lithium iron phosphate material with Rigaku's D/MAX2200PC model powder X-ray diffractometer is shown in FIG. 5.

### COMPARISON EMBODIMENT 4

This comparison embodiment describes the currently used method of synthesis for the cathode active material lithium iron phosphate.

Use the method described in Embodiment 11 to synthesize lithium iron phosphate, with the only difference being that in step (2), the mixture from step (1) is placed into a reaction container equipped with a gas inlet and gas outlet (with the gas inlet and gas outlet located on the same vertical plan of the container, the gas inlet being below the gas outlet); the gas inlet and gas outlet are opened, and carbon monoxide is pumped in at a rate of 5 L/min to replace the air in the reaction container, after which carbon monoxide continues to be pumped in; the temperature is raised at a rate of 10° C./min to 750° C. and sintering is conducted at that constant temperature for 20 hours. Afterwards, carbon monoxide continues to be pumped in to cool the resulting product down to room temperature to obtain the rechargeable lithium-ion battery cathode active material lithium iron phosphate. The produced lithium iron phosphate has a carbon content at 3.62% in weight.

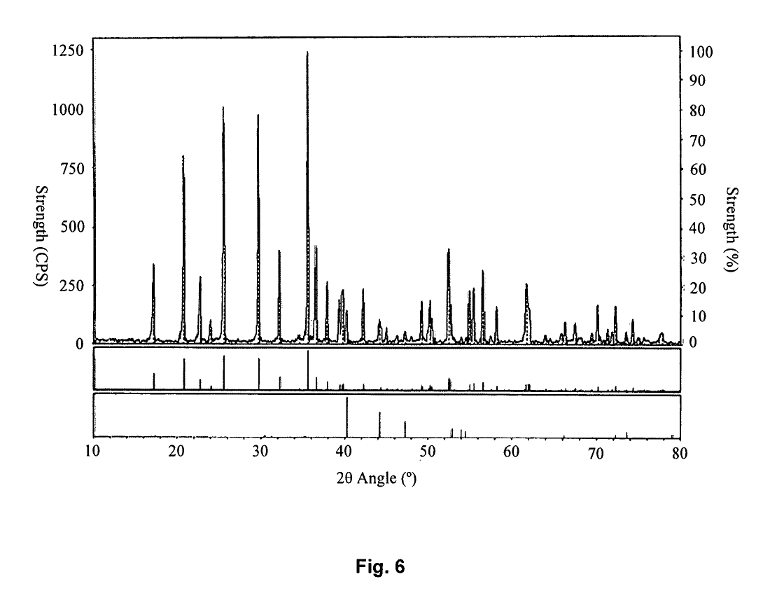

The XRD diffraction pattern produced by testing this lithium iron phosphate material with Rigaku's D/MAX2200PC model powder X-ray diffractometer is shown in FIG. 6.

### EMBODIMENTS 15-18

The following embodiments describe the testing of the properties of the batteries constructed using the cathode active substance lithium iron phosphate synthesized according to this invention.

(1) Battery Construction

Cathode Construction

Separately add 90 g of the cathode active substance LiFePO₄ created using the methods of Embodiments 11-14, 5 g of the bonding agent polyvinylidene fluoride (PVDF), and 5 g of the conductive agent acetylene black to 50 g of N-Methyl pyrrolidone, then mix in a vacuum mixer to form an even cathode slurry. Spread the obtained cathode slurry evenly over both sides of a 20 micrometer thick sheet of aluminum foil, then warm dry at 150° C., compress using a roller, and cut into cathodes measuring 540×43.5 mm, each containing 5.2 g of the active ingredient LiFePO₄.

Anode Construction

Add 90 g of the anode active ingredient natural graphite, 5 g of the bonding agent polyvinylidene fluoride, and 5 g of the conductive agent carbon black to 10 g of N-Methyl pyrrolidone, then mix in a vacuum mixer to form an even anode slurry. Spread the obtained anode slurry evenly over both sides of a 12 micrometer thick sheet of aluminum foil, then warm dry at 90° C., compress using a roller, and cut into cathodes measuring 540×44 mm, each containing 3.8 g of the active ingredient natural graphite.

Battery Assembly

Separately roll the obtained cathodes and anodes with a polypropylene membrane into a rectangular lithium-ion battery core, then dissolve LiFP₆ with a density of 1 mol/L in an EC/EMC/DEC=1:1:1 solvent mixture to produce a non-aqueous electrolyte solution; feed said electrolyte solution in an amount of 3.8 g/Ah into the aluminum battery shell and seal to separately produce rechargeable lithium ion batteries A1-A4.

(2) Test of Batteries' Properties

Separately place the A1-A4 lithium-ion batteries as created above in a testing cabinet; first charge at a constant flow and constant voltage of 0.2 C with a maximum voltage of 4.2V. Set the battery aside for 20 minutes, then discharge at a rate of 0.2 C from 4.2V down to 2.5V; record the battery's initial discharge capacity, and use the formula below to calculate the batteries' mass specific capacity.

Mass specific capacity=battery's initial discharge capacity (mAh)/weight of cathode material (g)

Afterwards, repeat the above-described steps 30 and 50 times to separately obtain the batteries' 30- and 50-time capacities. Record the batteries' discharge capacities, and use the formula below to calculate pre- and post-cycling capacity retention rates:

Capacity Retention Rate=(Nth cycle discharge capacity/1^{st} cycle discharge capacity)×100%.

The results are provided in Chart 2.

(3) Test of Batteries' Internal Resistance

Separately place the A1-A4 batteries as described above in a BS-VR3 intelligent battery internal resistance tester (Guangzhou Qing Tian Industrial Company, Limited), place them under a 1 KHz AC signal, then use their AC voltage drops to obtain their internal resistances.

### COMPARISON EMBODIMENTS 5-6

The following comparison embodiments describe the testing of the properties of the batteries constructed using the cathode active substance lithium iron phosphate synthesized using the current method.

Use the method described in Embodiments 15-18 to create comparison batteries AC1-AC2, and test the initial discharge capacity and cycling properties of these batteries. Calculate their mass specific capacity, with the only difference being that the cathode active substances used in constructing the batteries are the comparison lithium iron phosphate cathode active substances obtained through Comparison Embodiments 3-4.

The results are shown in Chart 2.

CHART 2

| | | | 30-time | 50-time | |
|---|---|---|---|---|---|
| | | Mass | Cycling | Cycling | |
| | | Specific | Capacity | Capacity | Internal |
| Embodiment | Battery | Capacity | Retention | Retention | Resistance |
| Number | Number | (mAh/g) | Rate | Rate | (mΩ) |
| Embodiment | A1 | 151.63 | 99.02% | 98.25% | 19.78 |
| 15 | | | | | |
| Embodiment | A2 | 149.39 | 98.21% | 97.93% | 21.57 |
| 16 | | | | | |
| Embodiment | A3 | 149.16 | 98.00% | 97.01% | 22.42 |
| 17 | | | | | |
| Embodiment | A4 | 147.25 | 98.25% | 97.33% | 24.91 |
| 18 | | | | | |
| Comparison | AC1 | 113.26 | 93.28% | 90.85% | 230.48 |
| Embodiment | | | | | |
| 5 | | | | | |
| Comparison | AC2 | 108.73 | 92.21% | 88.83% | 276.54 |
| Embodiment | | | | | |
| 6 | | | | | |

Using Embodiment 11 and Embodiment 12 as references, FIG. 3 shows the XRD diffraction chart for the lithium iron phosphate obtained through Embodiment 11 of this invention, and FIG. 4 shows the XRD diffraction chart for the lithium iron phosphate obtained through Embodiment 12 of this invention. From the illustrations it can be seen that this lithium iron phosphate has a standard olive shape, an excellent crystal structure, and contains no impurities.

FIG. 5 shows a XRD diffraction chart for the lithium iron phosphate obtained through Comparison Embodiment 3 of this invention, and FIG. 6 shows a XRD diffraction chart for the lithium iron phosphate obtained through Comparison Embodiment 4 of this invention. From FIGS. 5 and 6 it can be seen that this lithium iron phosphate mixture contains Fe₂P impurities. (When compared with Fe₂P standard PDF card (85-1727), a peak appears in the 2θ angle range of 40°-41°, and a peak appears in the 2θ angle range of 44°-45°, indicating the presence of Fe₂P. From Illustrations 3 and 4 it can be clearly seen that these characteristic peaks are present.)

From the data in Chart 2 above it can be seen that the initial discharge mass specific capacities of batteries A1-A4 constructed using the synthesis method for lithium iron phosphate of this invention are all clearly higher than those of comparison batteries AC1 and AC2 from the comparison embodiments, and that their internal resistances are all lower than those of the comparison batteries. The batteries' 30-time cycling capacity retention rates are 98% or higher; the batteries' 50-time cycling capacity retention rates are 97% or higher. The comparison batteries' 30- and 50-time cycling capacity retention rates are 92.21%-93.28% and 88.83%-90.85%. This shows that batteries constructed using lithium iron phosphate synthesized through the method of this invention have high capacity, low internal resistance, and excellent cycling properties.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for synthesizing lithium iron phosphate as a material for the cathode of a lithium battery, comprising the steps of:
mixing a lithium source, an iron source, a phosphorous source, and a carbon source into a first mixture; and
sintering the first mixture;
wherein said iron source is a second mixture of FeC₂O₄ and FeCO₃, with a molar ratio of FeC₂O₄ to FeCO₃ being 1:0.5-4.

2. The method of claim 1, wherein the molar ratio of FeC₂O₄ to FeCO₃ is 1:1.5-4

3. The method of claim 1, wherein the second mixture of FeC₂O₄ and FeCO₃ is synthesized by the steps of mixing FeC₂O₄ and FeCO₃.

4. The method of claim 1, wherein the second mixture of FeC₂O₄ and FeCO₃ is synthesized by the steps of heating ferrous oxalate in a vacuum for 0.2-6 hours at a temperature of 100-350° C.

5. The method of claim 3, wherein the heating temperature is in the range of 120-300° C., heating time is 0.5-5 hours, and the vacuum pressure is 100-1000 Pa.

6. The method of claim 1, wherein a molar ratio of said iron source, lithium source, and phosphorous source being Fe:Li:P=1:0.95-1.1:0.95-1.1, and a quantity of the carbon source used being 0.5-10% by weight of the total quantity of the iron source, the lithium source, and the phosphorous source.

7. The method of claim 1, wherein, the lithium source is at least one element chosen from of the group consisting of lithium hydroxide, lithium carbonate, lithium acetate, lithium nitrate, lithium phosphate, lithium hydrogen phosphate, and lithium dihydrogen phosphate;
the phosphorous source is at least one element chosen from the group consisting of ammonium phosphate, ammonium hydrogen phosphate, ammonium dihydrogen phosphate, lithium phosphate, lithium hydrogen phosphate, and lithium dihydrogen phosphate; and
the carbon source is at least one element chosen from the group consisting of dextrose, sucrose, starch, and carbon black.

8. The method of claim 1, wherein the mixing step for the described lithium source, iron source, phosphorous source, and carbon source further comprises the steps of:
ball-milling the first mixture of the lithium source, iron source, phosphorous source and carbon source with a dispersing agent for 3-12 hours; and
warm-drying the first mixture at 30-80° C. for 2-10 hours, wherein the quantity of the dispersing agent used is 70-120% by weight of the total quantity of the iron source, the lithium source, the phosphorous source, and the carbon source.

9. The method of claim 1, wherein the sintering step further comprises the steps of:
conducting an initial sintering of the first mixture of the lithium source, iron source, phosphorous source, and carbon source at an initial sintering temperature in a protective environment of inert gas; and
conducting a second sintering of the first mixture at a second sintering temperature;
wherein said initial sintering temperature is 300-450° C., and said initial sintering time is 4-15 hours, said second sintering temperature is 600-800° C., and said second sintering time is 10-25 hours.

10. The method of claim 1, wherein the sintering step is performed in an inert gas environment; wherein the inert gas environment being a static inert gas environment, and the inert gas environment having a normal atmospheric pressure.

11. The method of claim 1, wherein said sintering step being conducted in a reaction container equipped with a gas inlet and a gas outlet,
before the sintering step, an inert gas is fed into the reaction container to replace the air in the reaction container; and
during the sintering step the gas inlet is kept closed, and the gas outlet is connected pressure-tight to one end of a tube, the other end of the tube is placed in a hydraulic fluid.

12. A method for synthesizing lithium iron phosphate as a material for the cathode of a rechargeable lithium-ion battery, comprising the steps of:
sintering a mixture of a lithium compound, a divalent iron compound, a phosphorous compound, and an carbon source additive in an inert gas environment; and
cooling the mixture to obtain a sintered product;
wherein the inert gas environment being a static inert gas environment, and the inert gas environment having a normal atmospheric pressure.

13. The method of claim 12, wherein said sintering step being conducted in a reaction container equipped with a gas inlet and a gas outlet,
before the sintering step, an inert gas is fed into the reaction container to replace the air in the reaction container; and
during the sintering step the gas inlet is kept closed, and the gas outlet is connected pressure-tight to one end of a tube, the other end of the tube is placed in a hydraulic fluid.

14. The method of claim 13, wherein the hydraulic fluid being a liquid that does not react with the gas produced during the sintering step and has a boiling point not lower than 140° C.

15. The method of claim 12, wherein said sintering step is a one-stage, constant temperature sintering, the sintering step further comprising the steps of:
heating at a rate of 5-20° C./min to a constant sintering temperature; and
sintering at said sintering temperature.
wherein said constant sintering temperature is 500-750° C., and sintering time is 2-20 hours.

16. The method of claim 12, wherein the molar ratio of Li:Fe:P in said lithium compound, said divalent iron compound, and said phosphorous compound is 0.9-1.2:1:1, and the amount of said carbon source additive used results in a carbon content of 1-10% in the produced lithium iron phosphate.

17. The method of claim 12, wherein said lithium compound is at least one element chosen from the group consisting of Li₂CO₃, LiOH, Li₂C₂O₄, and CH₃COOLi,
said divalent iron compound is at least one element selected from the group consisting of FeC₂O₄, Fe(CH₃COO)₂, and FeCO₃;
said phosphorous source is at least one element selected from the group consisting of NH₄H₂PO₄, (NH₄)₂HPO₄, and (NH₄)₃PO₄; and
said carbon source additive is at least one element selected from the group consisting of copoly(benzene/naphthalene/phenanthrene), copoly(benzene/phenanthrene), copoly(benzene/anthracene), polyphenyl, soluble starch, polyvinyl alcohol, sucrose, dextrose, citric acid, starch, dextrin, phenolic aldehyde resin, furfural resin, artificial graphite, natural graphite, super-conductive acetylene black, acetylene black, carbon black, and molecular and cellular medicine ball.

18. The method of claim 17, wherein said divalent iron source is a mixture of FeC₂O₄ and FeCO₃, with a molar ratio of FeC₂O₄ to FeCO₃ being 1:0.5-4.

19. The method of claim 12, wherein the inert gas is one or more of nitrogen, carbon monoxide, carbon dioxide, ammonia gas, and Group 0 gases.

20. A method for synthesizing lithium iron phosphate as a material for the cathode of a lithium battery, comprising the steps of:
mixing a lithium source, an iron source, a phosphorous source, and a carbon source into a first mixture; and
sintering the first mixture under a inert gas environment;
wherein the inert gas environment being a static inert gas environment, and having a normal atmospheric pressure;
wherein said iron source is a second mixture of FeC₂O₄ and FeCO₃, with a molar ratio of FeC₂O₄ to FeCO₃ being 1:0.5-4;
wherein said sintering step being conducted in a reaction container equipped with a gas inlet and a gas outlet, before the sintering step, an inert gas is fed into the reaction container to replace the air in the reaction container; and during the sintering step the gas inlet is kept closed, and the gas outlet is connected pressure-tight to one end of a tube, the other end of the tube is placed in a hydraulic fluid; and
wherein the hydraulic fluid being a liquid that does not react with the gas produced during the sintering step and has a boiling point not lower than 140° C.
